(19) United States
(12) Patent Application Publication
(10) Pub. No.: US 2007/0073419 A1
(43) Pub. Date: Mar. 29, 2007

(54) Process control system and method for configuring a process control system

(76) Inventor: Sahid Abu-Bakarr Sesay, Beaconsfield (AU)

Correspondence Address: PILLSBURY WINTHROP SHAW PITTMAN, LLP, P.O. BOX 10500, MCLEAN, VA, 22102, US

(21) Appl. No.: 10/547,094

(22) PCT Filed: Feb. 26, 2004
(86) PCT No.: PCT/AU04/00243

§ 371 Date: Jul. 26, 2006

(30) Foreign Application Priority Data
Feb. 26, 2003 (AU) 2003900854

(51) Int. Cl. G05B 11/01; G05B 19/42

(52) U.S. Cl. 700/18; 700/86; 700/87

(57) ABSTRACT

A process control system comprising: a programmable automation controller; and at least one process control peripheral. Each process control peripheral is in data and control communication with the programmable automation controller. Upon configuration of the process control system, the programmable automation controller executes a single software program to assist a user to (i) define prescribed information in respect of the process control peripheral, including configuration information; (ii) define trigger conditions, if any, associated with the process control peripheral; and (iii) define alarm conditions, if any, associated with the process control peripheral. Once configured, the software program is operable to provide information in respect of the process control system to the user.

### FIELD OF THE INVENTION

The present invention relates to a process control system and method for configuring a process control system. In particular, the process control system and method for configuring a process control system is adapted to be controlled by the end user without the need of the specialist expertise of a process control engineer or similarly capable person.

### BACKGROUND ART

The following discussion of the background of the invention is intended to facilitate an understanding of the invention. However, it should be appreciated that the discussion is not an acknowledgement or admission that any of the material referred to was published, known or part of the common general knowledge of the person skilled in the art in any jurisdiction as at the priority date of the application.

The ability to monitor a process for a defect in that process and to improve the process is vital to the operation of much commerce. As an example, intensive farming ventures (where vegetable, fish, fowl or beast, is grown in a limited space with tightly controlled inputs) have typically deployed automation usually through the use of programmable logic controllers (“PLCs”). While this approach is functional there are many reasons that this is not of advantage.

The primary problem is that it is difficult for the end user to set up and later modify the control scheme. Typically, a process control engineer or similarly capable person is required to design a control process. Any improvement thereafter will also require their expertise. This is problematic as, while there may be known optimal control conditions for some situations, in many cases the control scheme will require adjustment or redesign to suit localised conditions.

Aquaculture, for example, covers a wide range of species each having different growing conditions. As well as this, pond and tank sizes may vary leading to the need to find the optimum control process by trial and continuous improvement methods. If control expertise is needed at each trial stage this will be costly. Furthermore, many ventures are located in rural areas where such expertise is not readily available. This results in inconvenience, increased cost and a considerable time lag in implementing growing cycle improvements. Each venture then finds it difficult to optimise and improve its competitive advantage.

PLC systems have other disadvantages. A PLC needs to be placed relatively close to the phenomena under measurement or control. Proprietary protocols are used to communicate with and to program the PLC typically by using ‘ladder logic’. The process control engineer generally uses a first software package to do this. Furthermore, the process control engineer needs to use a second software package to configure the PLCs. Yet another software package is needed to view the operation of the PLCs, be it over the internet or locally.

The requirement for such separate software packages adds complexity and physical cost as well as increasing the time needed to program the system. This also translates into a higher total cost of ownership where, the cost of equipment being equal, the engineering time to program and manage systems is significant.

It is an object of the present invention to provide a process control system that overcomes, or at least alleviates, at least one of the aforementioned problems.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the invention there is a process control system comprising a programmable automation controller and at least one process control peripheral, each process control peripheral in data and control communication with the programmable automation controller, wherein, upon configuration of the process control system, the programmable automation controller executes a single software program to assist a user to
define prescribed information in respect of the process control peripheral, including configuration information;
define trigger conditions, if any, associated with the process control peripheral; and
define alarm conditions, if any, associated with the process control peripheral,
   the software program thereafter being operable to provide information in respect of the process control system to the user.

Preferably, the prescribed information includes high and low raw input values. The prescribed information may also include, if the process control peripheral is, at least in part, a digital device, the prescribed information includes default device state information. Alternatively, or conjunctively, the prescribed information may include, if the process control peripheral is, at least in part, an analogue device, the prescribed information includes high and low engineering values and measurement increment information.

More preferably, the prescribed information includes at least one of the following:
details of whether the process control peripheral is bipolar;
details of whether the process control peripheral is a DE device;
default output value.

The software program may be operable to scan all input/output ports of the programmable automation controller for process control peripherals and obtain predetermined details regarding each process control peripheral detected. The software program may then provide the predetermined details in respect of each detected process control peripheral to the user and receive confirmation from the user that the predetermined details correspond with the process control peripherals in data and control communication with the programmable automation controller.

Preferably, the software program is operable to assist the user to define a channel through which each process control peripheral sends data and control communications to the programmable automation controller. Ideally, however, the predetermined details includes details of a channel through which each process control peripheral sends data and control communication to the programmable automation controller obtained during the scan of all input/output ports.

Ideally, the software program is operable to assist the user to define at least one environment and to associate a shape with each defined environment. The software program then being operable include details of the environment to which the process control peripheral relates as part of the prescribed information.

Preferably, the prescribed information includes an image to be used to represent the process control peripheral.

Preferably, the process control system includes a display means in data communication with the programmable automation controller, the display means operable to display the image used to represent each process control peripheral within the display of the shape associated with the environment to which the process control peripheral relates, the user thereafter able to re-configure or view data on the operation of the process control system by appropriate manipulation of each image or shape.

Ideally, the programmable automation controller includes a database and the prescribed information includes an indication as to whether values recorded by the process control peripheral are to be logged in the database In this arrangement, it is preferable for the prescribed information to include details of the time interval to expire between logging values in the database.

Preferably, the prescribed information includes details of the active state of the process control peripheral and, the software program is operable to assist the user to schedule when the process control peripheral is to change to the active state. The prescribed information may also include
an indication of whether the process control peripheral is the subject of an alarm; and
an indication of whether the process control peripheral is the subject of, or catalyst for, a trigger condition.

In such an arrangement the software program may be operable to verify that each process control peripheral indicated as being the subject of an alarm is the subject of a defined alarm condition and that each process control peripheral indicated as being the subject of, or catalyst for, a trigger condition is the subject of, or catalyst for, a defined trigger condition.

Preferably, a defined alarm condition includes details of the method of alarm. The method of alarm may include at least one of the following: Short Message Service message; e-mail; pager; speaker; phone or a message by any other communications means as may come into common use.

Preferably, the defined trigger condition includes details of the time period to elapse before rechecking the trigger condition and a response, the response being initiated if the trigger condition still exists on rechecking.

Preferably, the software program includes means for simulating the operation of the process control system.

Preferably, the process control peripheral is one of: sensor, actuator or camera. Ideally, data and control communication accords with a non-proprietary communication protocol. In its most preferred arrangement, data and control communication is effected by one of the following means: cable, wireless, infrared or PCI/ISA card.

Preferably, the user is located remote to the programmable automation controller and the single software program is adapted to assist the user via a remote computer. The remote computer may be one of the following: notebook computer; hand-held PC; personal digital assistant; tablet PC; desktop PC; mobile phone.

In accordance with a second aspect of the invention there is a method for configuring a process control system comprising:
establishing data and control communication between a programmable automation controller and at least one process control peripheral; and
defining prescribed information in respect of the process control peripheral, including configuration information, via a single software program;
defining trigger conditions, if any, associated with the process control peripheral using the software program; and
defining alarm conditions, if any, associated with the process control peripheral using the software program.

Preferably, the step of defining the prescribed information includes the step of defining high and low raw input values. More preferably, the step of defining the prescribed information includes the step of defining default device state information if the process control peripheral is, at least in part, a digital device. Still more preferably, the step of defining the prescribed information includes the step of defining high and low engineering values and measurement increment information if the process control peripheral is, at least in part, an analogue device.

Preferably, the step of defining the prescribed information includes the step of defining at least one of the following:
details of whether the process control peripheral is bipolar;
details of whether the process control peripheral is a DE device;
default output value.

Preferably, the method includes the further steps of scanning all input/output ports of the programmable automation control for process control peripherals; and obtaining predetermined details regarding each process control peripheral detected. The method may then include the further steps of providing the predetermined details in respect of each detected process control peripheral to the user; and receiving confirmation from the user that the predetermined details correspond with the process control peripherals in data and control communication with the programmable automation controller.

Preferably, for each process control peripheral, the method includes the step of defining a channel through which the process control peripheral sends data and control communications to the programmable automation controller using the software program.

Preferably, the method includes the further step of automatically identifying each channel through which each process control peripheral send data and control communication to the programmable automation controller and providing that information as part of the determined details.

Preferably, the method includes the further steps of defining at least one environment and associating a shape with each defined environment. More preferably, the method includes the step of associating each process control peripheral with a defined environment.

Preferably, the method includes the step of defining an image to be used to represent the process control peripheral. Ideally, the method then includes the step of displaying, for each process control peripheral, the image used to represent each process control peripheral within the display of the shape associated with the environment to which the process control peripheral relates.

Preferably, the method includes the step of indicating whether values recorded by the process control peripheral are to be logged in a database. Ideally, the method includes the step of defining the time interval to expire between logging of values in the database.

Preferably, the method includes the additional steps of detailing the active state of the process control peripheral and, using the software, assisting the user to schedule when the process control peripheral is to change to the active state. More preferably, the method includes the still additional steps of indicating whether the process control peripheral is the subject of an alarm; and indicating whether the process control peripheral is the subject of, or catalyst for, a trigger condition.

Preferably, the method includes the steps of verifying that each process control peripheral indicated as being the subject of an alarm is the subject of a defined alarm condition; and verifying that each process control peripheral indicated as being the subject of, or catalyst for, a trigger condition is the subject of, or catalyst for, a defined trigger condition.

Preferably the method includes the step of defining a method of alarm from one of the following: Short Message Service message; e-mail; pager; speaker; phone.

Preferably, the method includes the steps of detailing a time period to elapse before rechecking the trigger condition and a response to the trigger condition and initiating the response if the trigger condition still exists on rechecking.

In accordance with a third aspect of the invention there is a programmable automation controller for use in a process control system, the programmable automation controller in data and control communication with at least one process control peripheral, the programmable automation controller being operable to execute a single software program to assist a user to:
define prescribed information in respect of each process control peripheral, including configuration information;
define trigger conditions, if any, associated with the process control peripheral; and
define alarm conditions, if any, associated with the process control peripheral
   the software program thereafter being operable to provide information in respect of the process control system to the user.

Preferably, the software program is operable to scan all input/output ports of the programmable automation controller for process control peripherals and obtain predetermined details regarding each process control peripheral detected. More preferably, the software program is operable to provide the predetermined details in respect of each detected process control peripheral to the user and receive confirmation from the user that the predetermined details correspond with the process control peripherals in data and control communication with the programmable automation controller.

Preferably, the software program is operable to assist the user to define a channel through which each process control peripheral sends data and control communication to the programmable automation controller. The software program may also be operable to assist the user to define at least one environment and to associate a shape with each defined environment.

Ideally, the software program is operable to display on a display means an image used to represent each process control peripheral within the display of the shape associated with the environment to which the process control peripheral relates.

Preferably, the programmable automation controller includes a database for recording values recorded by prescribed process control peripherals.

Preferably, the software program is operable to verify that each process control peripheral indicated as being the subject of an alarm is the subject of a defined alarm condition and that each process control peripheral indicated as being the subject of, or catalyst for, a trigger condition is the subject, or defined catalyst for, a defined trigger condition. The software program may also include means for simulating the operation of the process control system.

Preferably, data and control communication with the at least one process control peripheral accords with a non-proprietary communication protocol. More preferably, data and control communication with the at least one process control peripheral is effected by at least one of the following means: cable, wireless, infrared or PCI/ISA card.

Preferably, the software program is adapted to assist the user located remote to the programmable automation controller via a remote computer.

In accordance with a fourth aspect of the invention there is a computer for use in a process control system, the computer in data and control communication with at least one remote programmable automation controller, the at least one remote programmable automation controller in data and control communication with at least one process control peripheral, wherein, upon configuration of the process control system, the at least one remote programmable automation controller executes a single software program to assist a user of the computer to:
define prescribed information in respect of the at least one process control peripheral, including configuration information;
define trigger conditions, if any, associated with the at least one process control peripheral; and
define alarm conditions, if any, associated with the process control peripheral,
   the software program thereafter being operable to provide information in respect of the process control system to the user via the computer.

### BRIEF DESCRIPTION OF THE DRAWINGS

The invention will now be described with reference to the following figures, where:

FIG. 1 is a schematic of the hardware components of a first embodiment of a process control system the subject of the present invention.

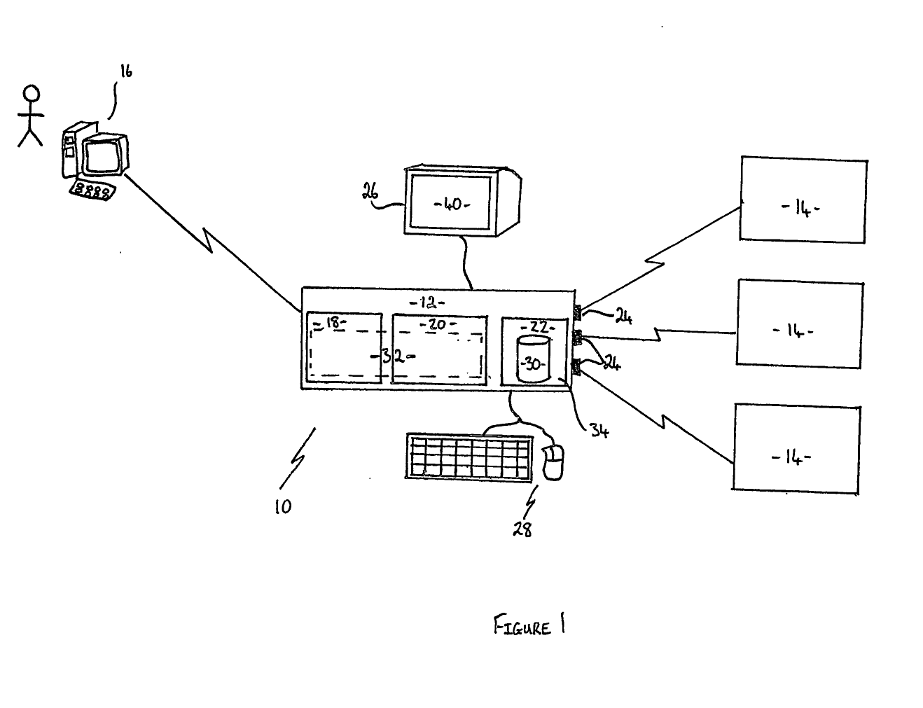

FIG. 2 is a screen capture of an environment definition screen of the process control system of FIG. 1.

FIG. 3 is a screen capture of a first device definition screen of the process control system of FIG. 1 showing a digital output form window in full.

FIG. 4 is a screen capture of the first device definition screen of FIG. 3 also showing an analogue input form window in full.

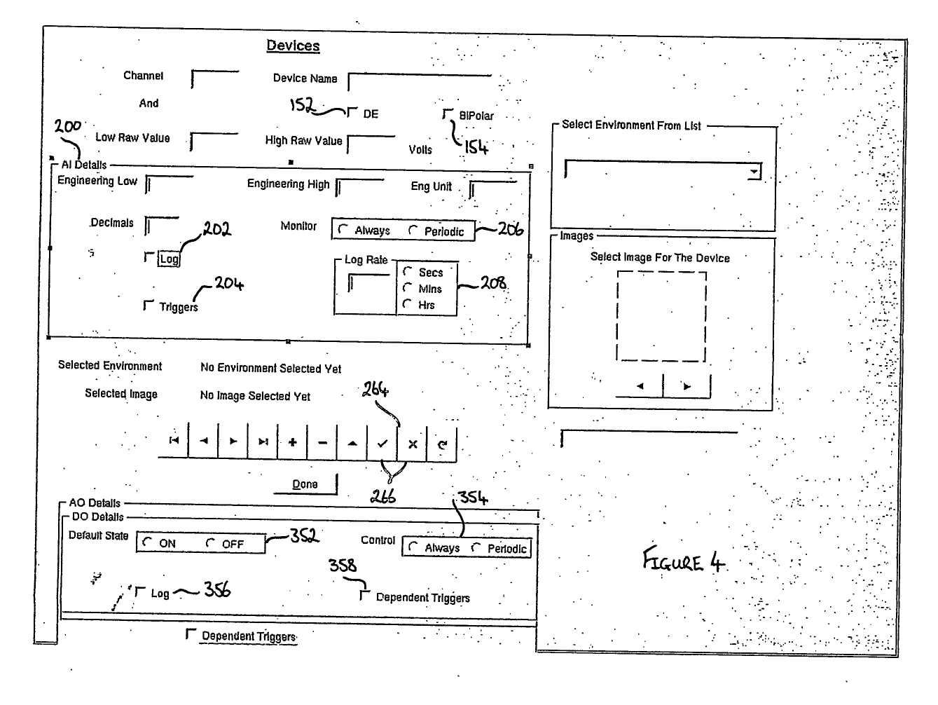

FIG. 5 is a screen capture of the first device definition screen of FIG. 3 also showing an analogue output form window and digital input form window in full.

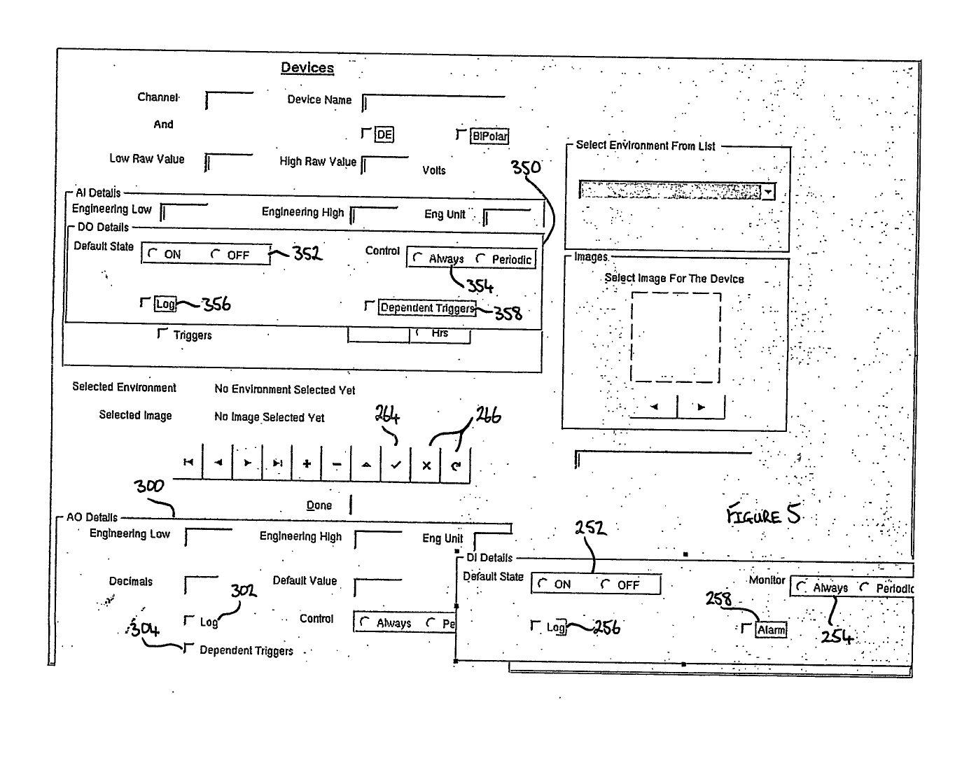

FIG. 6 is a screen capture of a trigger setting form window of the process control system of FIG. 1.

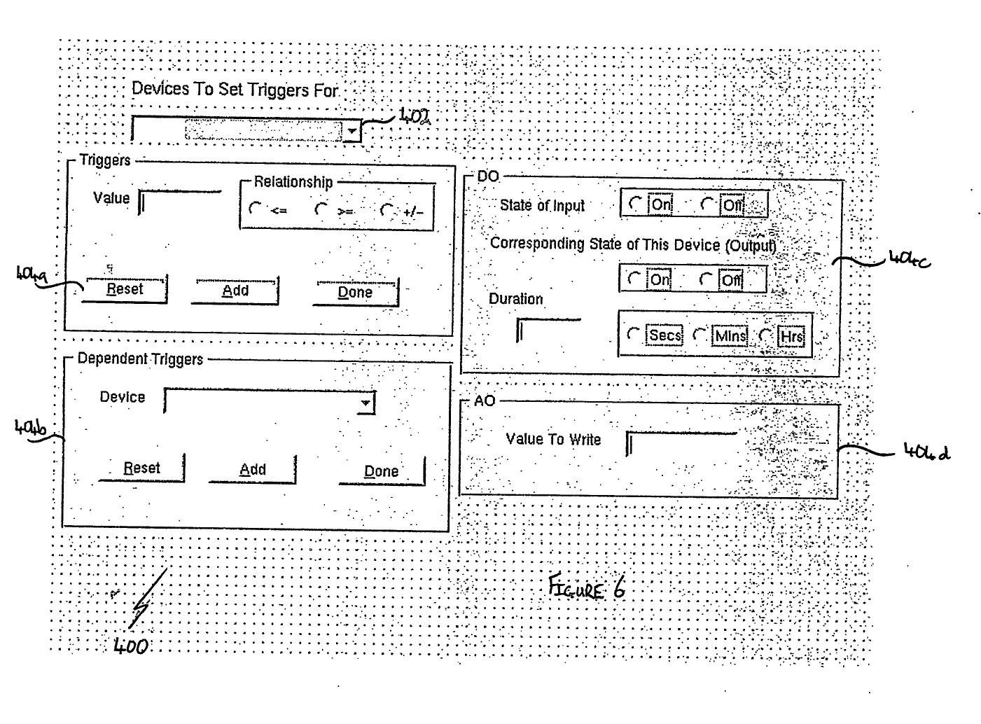

FIG. 7 is a screen capture of an alarm setting form window of the process control system of FIG. 1.

FIG. 8 is a screen capture of a schedule setting form window of the process control system of FIG. 1.

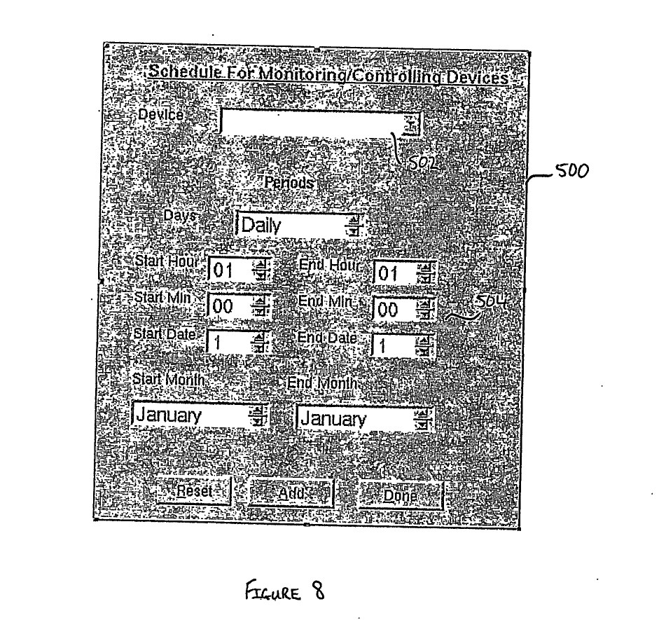

FIG. 9 is a screen capture of a user interface of the process control system of FIG. 1.

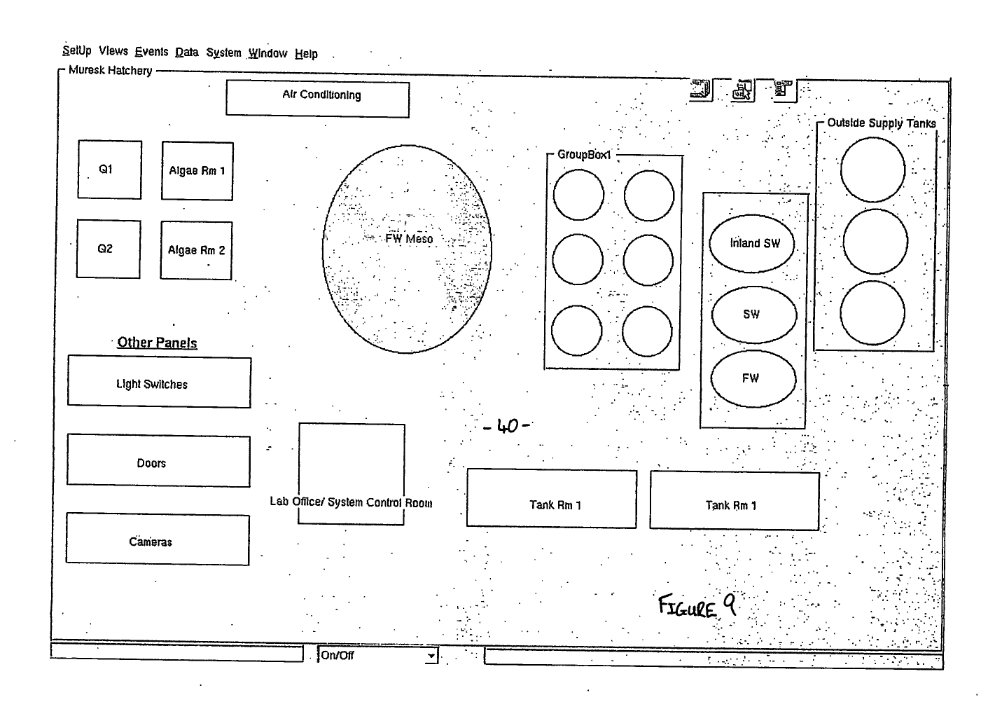

### BEST MODE(S) FOR CARRYING OUT THE INVENTION

In accordance with a first embodiment of the invention there is a process control system 10 comprising:
a programmable automation controller (“PAC”) 12;
at least one process control peripheral 14; and
optionally, a computer 16 located remotely from the PAC 12.

The PAC 12 comprises memory 18, processor 20, storage means 22 and I/O ports 24. In this embodiment, PAC 12 also includes display means 26 and data input means 28, in the form of a keyboard and mouse.

Storage means 22 includes a database 30. Storage means 22 may take a variety of forms including a fixed or removable hard disc or solid state memory means. Similarly, I/O ports 24 may take a variety of forms including cable, wireless, infrared and PCI/ISA card.

The PAC 12 is in data communication with both the at least one process control peripheral 14 and remote computer 16 through I/O ports 24. The remote computer 16 is in control communication with the PAC 12. The PAC 12 is in control communication with the at least one process control peripheral 14. In this example, data and control communication is achieved through non-proprietary communication standards, such as TCP/IP and Bluetooth.

The at least one process control peripheral 14 may be a sensor, an actuator or a video camera. Computer 16 is typically of standard configuration as would be evident to the person skilled in the art.

In use, the process control system 10 operates as follows.

A user, who may or may not be a process engineer or other similarly skilled person, installs the at least one process control peripheral 14 at a desired location. The user then installs the PAC 12 at an additional desired location and takes such action as necessary to secure data and control communication between the PAC 12 and the at least one process control peripheral 14. In this example, the user also takes such action as necessary to secure data and control communication between the PAC 12 and computer 16.

The remainder of this example will be discussed in the context of the user configuring the process control system 10 using the display means 26 and data input means 28 connected to the PAC 12. It should be appreciated, however, that the configuration process can be initiated and controlled via computer 16 through appropriate modification as would be known to the person skilled in the art.

Configuring the process control system 10 commences with the user executing software 32 recorded on storage means 22. Execution of the software 32 is achieved through appropriate use of processor 20 and memory 18.

Software 32 commences with a registration process for authenticating the identity of the user. Once authenticated, software 32 checks to see whether the process control system 10 has previously been configured by checking for the existence of a peripheral configuration file 34.

If the process control system 10 has not previously been configured, the software 32 scans the I/O ports 24 for any process control peripherals 14. Upon detection of a process control peripheral 14, the software 32 operates to obtain details of the process control peripheral 14. In this manner, software 32 operates in a manner similar to the “plug and play” procedure known to the person skilled in the art.

When the scan of all I/O ports 24 is complete, the details obtained in respect of each process control peripheral 14 are displayed to the user via display means 26. The user is then asked to confirm, using data input means 28, that the details of all process control peripherals 14 displayed on the display means 26 correspond with all process control peripherals 14 connected to the PAC 12. Upon confirmation, software 32 queries the user as to whether they wish to proceed to define environments within the process control system 10.

If the software 32 is unable to detect any process control peripheral 14, or the user cannot confirm correlation, the user is prompted to check that the process control peripheral 14 is properly connected and powered before the software 32 initiates a re-scan. Alternatively, the user may terminate execution of the software 32.

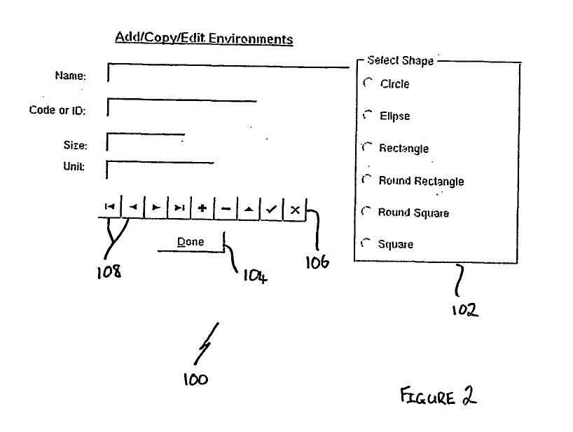

If the user proceeds to define environments, a form window 100, as shown in FIG. 2, is displayed to the user via display means 26. Form window 100 requires the user to enter in the following data:
the name to be given to the environment. An environment may take its name from the location where some of the process control peripheral 14 is sited, for example “Tank 001”, or may take the form of an indication of the object upon which some of the process control peripheral's 14 function, for example “Lights”.
An identifying code;
A description of the size in units; and
A description of the unit used to measure size, ie. liters, square meters, gallons, etc.

The user is also prompted to select a shape from radio button grouping 102 to be used when displaying the environment. This is explained in more detail below.

The user can view and/or modify the defined environments, as well as add yet further environments, by means of tool bar 106. The icons 108 on toolbar 106 allow the user, from left to right, to:
view the first defined entry;
view the previous defined entry;
view the next defined entry;
view the last defined entry;
edit the current defined entry;
delete the current defined entry;
add a new entry;
reset the current entry; and
cancel defining the current entry.

When the user has defined all the environments applicable to the process to be controlled, the user selects the done button 104. Software 32 then commits the defined environments as records of the appropriate tables in database 30.

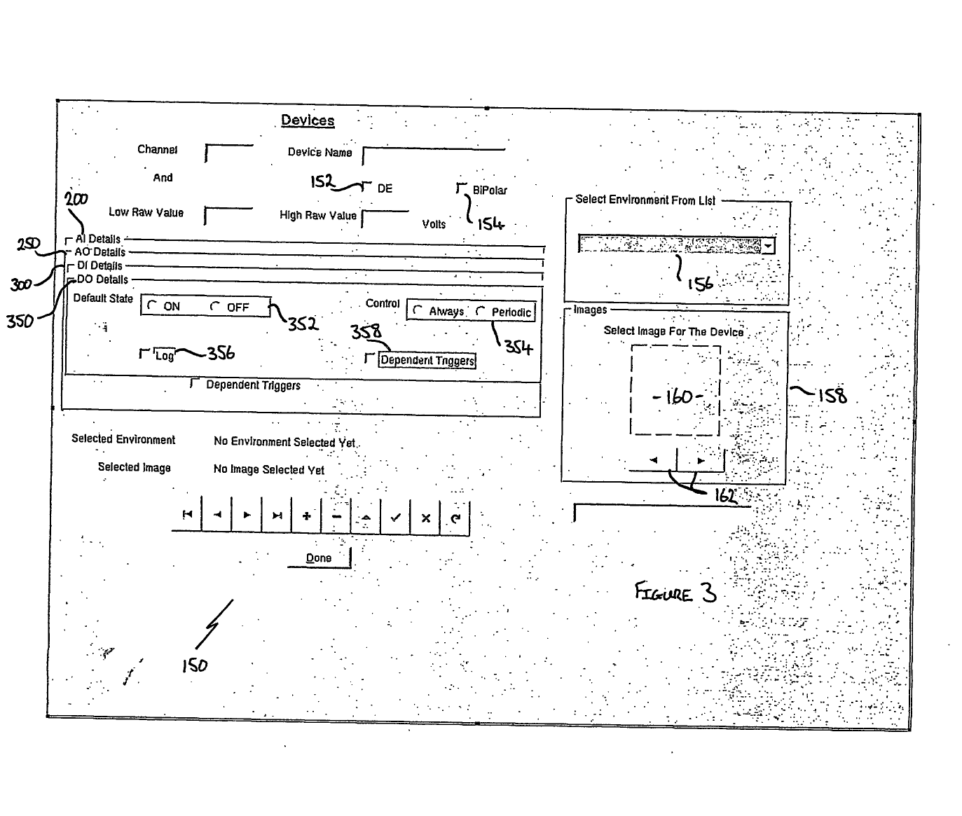

The user is then presented with form window 150, as shown in FIG. 3 (which replaces form window 100 if displayed). Form window 150 displays information in respect of the first process control peripheral 14 discovered during the scan of the I/O ports 24. Subsequent representations of window 150 each relate to a further process control peripheral 14 discovered during the scan of the I/O ports 24.

Form window 150 requires the user to enter the following information:
The name to be used to identify the process control peripheral 14; and
The channel through which the PAC 12 connects to the process control peripheral 14. Typically, this is a number.
The Low Raw Value of the process control peripheral 14. This corresponds with the minimum electrical signal generated by the process control peripheral 14.
The High Raw Value of the process control peripheral 14. This corresponds with the maximum electrical signal generated by the process control peripheral 14.

Typically, the latter two pieces of information can be obtained from the operating specifications of the process control peripheral 14.

The user is also directed to provide further information in respect of the process control peripheral 14 by:
Clicking on check box 152 if the process control peripheral 14 is either ground referenced (Single Ended or SE) or differential (Double Ended or DE);
Clicking on check box 154 if the process control peripheral 14 is bipolar.
Selecting an environment from drop down list 156. Drop down list 156 includes the names of all environments stored in database 30. If no environments have been defined, drop down list 156 is inaccessible to the user.
Selecting an image with which to represent the process control peripheral 14 from a slide-show 158. Selectable images are displayed on a rotational basis within window 160 by using directional buttons 162. The default state of window 160 is to display no image.

Whether the process control peripheral 14 is a differentiator or is bipolar can typically be obtained from the operating specifications of the process control peripheral 14.

Upon display of form window 150, additional form windows 200, 250, 300, 350 are arranged in a cascading fashion and in a manner so as not to intrude upon view of the data entry areas of form window 150. These form windows represent, in order, analogue input form window 200, analogue output form window 250, digital input form window 300 and digital output form window 350.

Analogue input form window 200 directs the user to enter in the following information:
The Low Engineering Value of the process control peripheral 14. This corresponds with the minimum value of the factor to be measured the process control peripheral 14 is capable of measuring.
The High Engineering Value of the process control peripheral 14. This corresponds with the maximum value of the factor to be measured the process control peripheral 14 is capable of measuring.
The Engineering Unit. This is the measurement unit used in measuring the factor to be measured.
The number of decimal places to be taken into consideration in any measurement.

Again, the first two pieces of information can typically be obtained from the operating specifications of the process control peripheral 14. Furthermore, by comparing the engineering values with the raw values, it is possible to determine the correlation between a value of little meaning to a user (ie. the raw electrical value) and a value of significant meaning to a user (ie. the engineering value). This then allows data communication to the user to be conducted on the basis of the engineering value alone.

The user is also directed to provide additional information in the form of:
clicking on log checkbox 202 if the input values generated by the process control peripheral 14 are to be logged in the appropriate table of database 30. If this checkbox 202 is set, the user is also directed towards radio button grouping 208. Radio button grouping 208 lets the user set the time interval to elapse between logging input values generated by the process control peripheral 14.
clicking on check box 204 if the input provided by the process control peripheral 14 will be used as a trigger for action by this process control peripheral 14.
Selecting whether this process control peripheral 14 is an always active component of the process control system 10 or a periodic active component.

Digital input window 250 comprises two radio button sets 252, 254 and two check boxes 256, 258. Radio button set 252 represents the default input state of the process control peripheral 14—ie. off or on. Radio button set 254 represents whether the process control peripheral 14 is an always active component of the process control system 10 or a periodic active component. The user is directed to choose the appropriate radio button from each radio button set 252, 254 as suits circumstances.

The user is also directed to click on check box 256 if the input values generated by the process control peripheral 14 are to be logged in the appropriate table of database 30. Similarly, the user is directed to click on check box 258 if the input values provided by the process control peripheral 14 are to be monitored for alarm purposes.

Analogue output form 300 directs the user to enter in the following information:
The Low Engineering Value of the process control peripheral 14.
The High Engineering Value of the process control peripheral 14.
The Engineering Unit.
The number of decimal places to be taken into consideration in any measurement.
The default output value.

Each of the first four items described in the preceding list correspond with the information requested in the analogue input form window 200.

The user is also directed to provide additional information in the form of:
clicking on log checkbox 302 if the output values generated by the process control peripheral 14 are to be logged in the appropriate table of database 30.
clicking on check box 304 if the output provided by the process control peripheral 14 will be used as a catalyst trigger for action by another process control peripheral 14.
Selecting whether this process control peripheral 14 is an always active component of the process control system 10 or a periodic active component.

Digital output form window 350 comprises two radio button sets 352, 354 and two check boxes 356, 358. Radio button set 352 represents the default output state of the process control peripheral 14—ie. off or on. Radio button set 354 represents whether the process control peripheral 14 is an always active component of the process control system 10 or a periodic active component. The user is directed to choose the appropriate radio button from each radio button set 352, 354 as suits circumstances.

The user is also directed to click on check box 356 if the output values of the process control peripheral 14 are to be logged in the appropriate table of database 30. Similarly, the user is directed to click on check box 358 if the output provided by the process control peripheral 14 will be used as a possible trigger for action by another process control peripheral 14.

Once the user has sought to define each process control peripheral's operating parameters, the configuration process continues on the user clicking on control button 162. At this stage, the information recorded in respect of each process control peripheral is then written to peripheral configuration file 34

Alternatively, the user may view and/or modify the defined parameters, as well as add yet further parameter information, by means of tool bar 264. The icons 266 represented on toolbar 264 perform the same actions as those represented on toolbar 106, albeit in respect of different data. The last icon 266 on toolbar 264 allows the user to skip entering information in respect of the then current process control peripheral 14.

With at least some of the process control peripheral's 14 operating parameters having been defined, the user is then prompted to set the triggers applicable to each process control peripheral 14 in trigger form window 400.

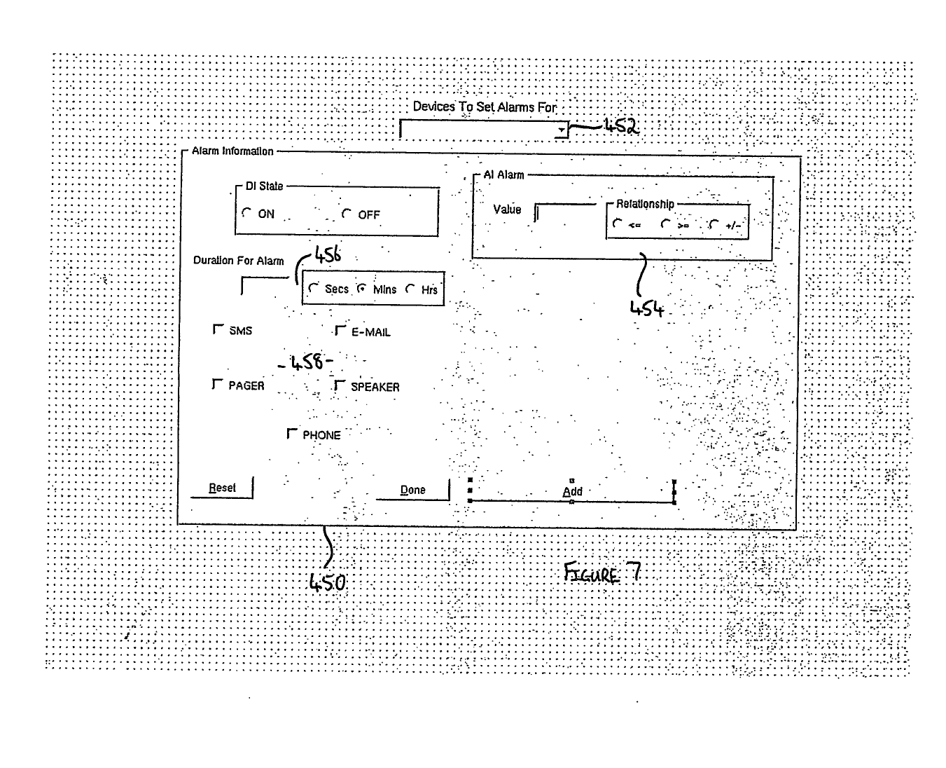

Trigger form window 400 comprises a pull down menu 402 and four data areas 404a, 404b, 404c and 404d (see FIG. 7). Pull down menu 402 contains a list of process control peripherals 14 for which the user previously indicated will be involved in trigger processing from which the user is to select.

In data area 404a, the user sets the trigger condition as a mathematical equation. In data area 404b, the user chooses the process control peripheral 14 upon which the trigger condition will operate. In data area 404c, the user sets the input/output correlation between the device selected via pull down menu 402 and the device selected via data area 404b upon activation of a trigger condition. The user also sets the time duration to wait before rechecking that the trigger condition exists—thereby preventing a trigger from activating on a single anomalous value. In data area 404d the user sets the analogue output value to be provided upon activation of a trigger condition. Confirmation of each trigger condition is attained by means of control buttons 410.

Alert form window 450 includes a pull down menu 452. Pull down menu 452 contains a list of process control peripherals 14 for which the user previously indicated will be involved in alarm processing from which the user is to select.

Alarms can be activated on the basis of a digital input value or an analogue input value. In the case of an analogue input value the conditions for the alarm can be specified by the user using the field and radio button combination of data input area 454. The user is also directed to set the time duration for the alarm at data input area 456. Finally, the user is directed to provide an indication as to the method of communicating the alarm by clicking on one or more of checkboxes 458.

Finally, the user is directed towards scheduling form window 500. Scheduling form window 500 comprises a pull-down list 502. Pull down list 502 contains a list of all process control peripherals 14 previously identified as being periodically active. The user may then select any such process control peripheral 14 and, using the fields set out in data entry area 504, schedule the times of operation of that process control peripheral 14.

As each form window operates independently of each other form window, it is possible for the user to exit the configuration process at any stage. When this occurs, and on completion of the configuration process, the user is displayed a human/machine interface (“HMI”) 40 via display means 26. HMI 40 displays to the user all environments specified by the user in respect of the process to be controlled. Each environment is depicted in the HMI 40 by its selected shape with its name displayed in close proximity. Where a process control peripheral 14 has been specified by the user as related to an environment, the process control peripheral is also displayed in the HMI 40 by its selected image and name—the image and name being contained within the shape of the related environment.

The user is then free to view information in respect of any environment or process control peripheral as they see fit by double-clicking on the shape or image, as appropriate. The user may also re-configure the process control system 10, or any part thereof, by accessing the appropriate form window and changing the values recorded therein. Where appropriate, these changes are then committed to the peripheral configuration file 34. Re-configuration may also occur on addition of further process control peripherals 14. In such a case, software 32 operates to conduct a further scan of all I/O ports 24 to discover the new process control peripherals 14. Processing in respect of the new process control peripherals 14 occurs in the same manner as if such process control peripherals 14 were discovered as part of the initial configuration process.

Due to the interrelationships defined by the various form windows, software 32 is able to facilitate simulations aimed at testing the operation of the defined process control system 10. This allows users to verify the process control system 10 operates as intended before being put into commercial operation. Furthermore, software 32 can assess the various process control peripheral 14 information to determine such errors as:
Whether all process control peripherals specified as being associated with trigger conditions are actually associated with a trigger condition.
Whether all process control peripherals specified as being periodically active are scheduled to operate at least once; and
Whether all process control peripherals 14 specified as being subject to alarm processing have set alarm criteria.

The system may then operate in accordance with the parameters set by the user and as would be apparent to the person skilled in the art.

A second user may access current data and data stored in database 30 of the PAC 12 via computer 16. In this manner, the second user can monitor the process control peripherals 14 and the operation of the PAC 12 from a remote location. Furthermore, the second user can conduct a series of queries on the communicated data directed towards such issues as:
detecting and analysing past and present data trends;
providing supporting data for quality assurance and/or regulatory requirement purposes;
analysing past performance as a means of improving the monitored process;
repeating past successes; and
make comments that are associated with the timestamped data.

The information resulting from these queries may be embodied in reports and a report generation tool is included for such purposes.

In accordance with a second embodiment of the invention, where like numerals reference like parts, there is a process control system 10 as described in the pseudocode attached as Appendix A.

As can be appreciated by the person skilled in the art, the invention is neither limited to a particular application environment nor limited to the embodiments described. For example:
The invention may be used in the reticulation/irrigation sector as a means of controlling solenoids, valves, tensiometers and pumps.
The invention may be used in the security sector as a means of controlling alarms, speakers and sirens as well as being able to stream and capture image data from close circuit cameras within the secured area. Alternatively, or conjunctively, the invention may be used to inform employees within a secured area of the presence of a visitor who has come to see them or an intruder.
The invention may be used to detect gas or other hazards and implement a response procedure to such hazard;
The invention may be incorporated as part of a weather station to detect temperature, wind, rain and dew levels.
The invention may be used to control an air conditioning system based on readings taken from an associated thermometer and heat exchanger.
The invention may be used to control lighting requirements based on such factors as time, detected movement and background illumination level.
The invention may be used in the water quality sector to monitor and control factors such as dissolved oxygen, temperature, pH, ORP, salinity, turbidity, water level and flow rate.

It should also be appreciated by the person skilled in the art that the invention is not limited to the embodiments described. In particular, the system may be modified to increase the level of automation with the user configuring the process control system by means of verifying, and modifying where appropriate, the automated definitions produced by software 32. Additionally, features described in each embodiment may, where not alternatives, be combined to form yet further embodiments.

APPENDIX A
Software main module is executed

Read system file

System file has info about prior activities

Prior activities:
system run before or not
system configured before or not
what DAQ card configured
were logins set (users added, how many, etc.)
system shut down - gracefully or not

Displays interface based on information in system file

First time run

Welcome interface displayed
Choice to secure login
Main Menu

Not first time run

Welcome interface displayed
Secure login interface if set

Else choice/icon to set secure login

Main Menu
Info about last shutdown displayed

End user presented with choices from Main Menu

If no prior configuration

Main Menu Icons comprise:
Tutorial
Configuration
Test Channels (read/write from/to channel and display)
Admin functions
Shutdown

If prior configuration

Main Menu icons comprise
Tutorial
Configuration
Control devices/channels
Admin functions
Shutdown

Configuration

If prior config = yes

Inform end user and display choices

Choices - reset (re-initialise), modify, no-change

Reset/Modify

Card OR Channels
Zero out respective config file

No-change

Loads respective config files

If prior config = no

Ask if card is in system - yes/no

No - Advise to shutdown and insert card
Yes - ask if channels wired - yes/no

No - advise to shutdown and connect/wire
devices to channels
Yes - proceed to next question

What card to configure

DAQ Card

Choose from list of supported cards

System installs card

Successful installation
message OR
Error message
displayed

User selects channel from list (each channel config info saved to file)

System file updated (for number of channels configured)

For each analogue input channel

Bi/uni polar
Voltage or current signal (from list)
Signal range (potentially from list)
Engineering scale
Type of phenomena (potentially from list)
Label/Tag
Dependent channel(s)

Label
Low Low Value
Low Value
High Value
High High Value

Sample Rate

For each analogue output channel

Bi/uni polar
Voltage or current signal (from list)
Signal range (potentially from list)
Engineering scale
Type of phenomena (potentially from list)
Label/tag
Parent Channel

Label
Low/Off
High/On

Sample rate

For each digital channel

Direction (Out/In)
Voltage or current signal (from list)
Signal range (potentially from list)
Engineering scale
Type of phenomena (potentially from list)
Label/tag
Parent Channel

Label
Low/Off
High/On

Child Channel

Label
Low/Off
High/On

Sample rate
Timed?
If Direction = In(put)

Dependent Channel(s)

Video Card Configuration

Choose from list of supported cards

System installs cards
User selects channel/port from list
For each camera connected

Frame rate
Auto-brightness
Night compensate
Threshold value
E-mail address 1, 2 . . . n
SMS/Phone number 1, 2 . . . n
Monitor periods
Send e-mail alert?
Send SMS alert?

Each camera config info saved to file
System file updated
HMI with labels/tags and connections built

Admin functions

Add user

Set user priority/security level

Choice for more additions OR confirm and exit

Run system

Check for configuration flag set
If config flag set

Check for system running now

If system running now

Inform and do nothing or choice to
modify, view, tutorial etc.

Else

System proceeds with data
acquisition process (main event
that sets all channel values,
monitors and wait for event
triggers)

Else

Inform user no prior config
Choice to config, tutorial, exit/shutdown

Control Device/Channels

Menu presents icons for

Help (controls devices)
Display status (choice of devices/channels)
Display parameters (choice of devices/channels)
Test devices/channels (choice of devices/channels)
Modify parameters (choice of devices/channels)
Manual override (choice of devices/channels)
Activate I/O device (choice of devices/channels)
Shutdown I/O device (choice of devices/channels)
Main menu

Display status

Choose channel from list
Is channel configured or not

Yes - display state (active/not active)
No - inform user channel not configured

Choose to configure/test devices/exit

Display parameters

Choose channel from list
Read channel parameters record from config file
Display read channel parameters on screen
Prompt for done/more/print/modify parameters

Test devices/channels

Choose channel from list
Display status plus read or write
Select/enter value to read/write
Display result on screen
Prompt for done/more/print/save to file

Modify parameters

Choose channel from list
Display parameters from config file in Edit mode
Choice for more/update/cancel and exit

Manual override

Choose channel from list
System display status
Choice to modify status/update/done/more

Activate I/O device

Choose channel from list
System displays status
Choice to modify status/update/done/more/cancel

Shutdown I/O device

Choose channel from list
System display status
Choice to modify status/update/done/more
Confirm shut down.

1. A process control system comprising a programmable automation controller and at least one process control peripheral, each process control peripheral in data and control communication with the programmable automation controller, wherein, upon configuration of the process control system, the programmable automation controller executes a single software program to assist a user to
define prescribed information in respect of the process control peripheral, including configuration information;
define trigger conditions, if any, associated with the process control peripheral; and
define alarm conditions, if any, associated with the process control peripheral,
the software program thereafter being operable to provide information in respect of the process control system to the user.

2. A process control system according to claim 1 wherein the prescribed information includes high and low raw input values.

3. A process control system according to claim 1, wherein, if the process control peripheral is, at least in part, a digital device, the prescribed information includes default device state information.

4. A process control system according to claim 1 wherein, if the process control peripheral is, at least in part, an analogue device, the prescribed information includes high and low engineering values and measurement increment information.

5. A process control system according to claim 1 wherein the prescribed information includes at least one of the following:
details of whether the process control peripheral is bipolar;
details of whether the process control peripheral is a DE device;
default output value.

6. A process control system according to claim 1 wherein the software program is operable to scan all input/output ports of the programmable automation controller for process control peripherals and obtain predetermined details regarding each process control peripheral detected.

7. A process control system according to claim 6 wherein the software program is further operable to provide the predetermined details in respect of each detected process control peripheral to the user and receive confirmation from the user that the predetermined details correspond with the process control peripherals in data and control communication with the programmable automation controller.

8. A process control system according to claim 1 wherein the software program is operable to assist the user to define a channel through which each process control peripheral sends data and control communications to the programmable automation controller.

9. A process control system according to claim 6 wherein the predetermined details includes details of a channel through which each process control peripheral sends data and control communication to the programmable automation controller.

10. A process control system according to claim 1 wherein the software program is operable to assist the user to define at least one environment and to associate a shape with each defined environment.

11. A process control system according to claim 10 wherein the prescribed information includes details of the environment to which the process control peripheral relates.

12. A process control system according to claim 1 wherein the prescribed information includes an image to be used to represent the process control peripheral.

13. A process control system according to claim 12, wherein the software program is operable to assist the user to define at least one environment and to associate a shape with each defined environment and the prescribed information includes details of the environment to which the process control peripheral relates, including a display means in data communication with the programmable automation controller, the display means operable to display the image used to represent each process control peripheral within the display of the shape associated with the environment to which the process control peripheral relates, the user thereafter able to re-configure or view data on the operation of the process control system by appropriate manipulation of each image or shape.

14. A process control system according to claim 1 wherein the programmable automation controller includes a database and the prescribed information includes an indication as to whether values recorded by the process control peripheral are to be logged in the database

15. A process control system according to claim 14 wherein the prescribed information includes details of the time interval to expire between logging values in the database.

16. A process control system according to claim 1 wherein the prescribed information includes details of the active state of the process control peripheral and, the software program is operable to assist the user to schedule when the process control peripheral is to change to the active state.

17. A process control system according to claim 1 wherein the prescribed information includes:
an indication of whether the process control peripheral is the subject of an alarm; and
an indication of whether the process control peripheral is the subject of, or catalyst for, a trigger condition.

18. A process control system according to claim 17 wherein the software program is operable to verify that each process control peripheral indicated as being the subject of an alarm is the subject of a defined alarm condition and that each process control peripheral indicated as being the subject of, or catalyst for, a trigger condition is the subject of, or catalyst for, a defined trigger condition.

19. A process control system according to claim 1 wherein a defined alarm condition includes details of the method of alarm.

20. A process control system according to claim 19 wherein the method of alarm includes at least one of the following: Short Message Service message; e-mail; pager; speaker; phone.

21. A process control system according to claim 1 wherein the defined trigger condition includes details of the time period to elapse before rechecking the trigger condition and a response, the response being initiated if the trigger condition still exists on rechecking.

22. A process control system according to claim 1 wherein the software program includes means for simulating the operation of the process control system.

23. A process control system according to claim 1 wherein each process control peripheral is one of: sensor, actuator or camera.

24. A process control system according to claim 1 wherein data and control communication accords with a non-proprietary communication protocol.

25. A process control system according to claim 1 wherein data and control communication is effected by one of the following means: cable, wireless, infrared or PCI/ISA card.

26. A process control system according to claim 1 wherein the user is located remote to the programmable automation controller and the single software program is adapted to assist the user via a remote computer.

27. A process control system according to claim 1 wherein the remote computer is one of the following: notebook computer; hand-held PC; personal digital assistant; tablet PC; desktop PC; mobile phone.

28. A method for configuring a process control system comprising:
establishing data and control communication between a programmable automation controller and at least one process control peripheral; and
defining prescribed information in respect of the process control peripheral, including configuration information, via a single software program;
defining trigger conditions, if any, associated with the process control peripheral using the software program; and
defining alarm conditions, if any, associated with the process control peripheral using the software program.

29. A method for configuring a process control system according to claim 28, wherein the step of defining the prescribed information includes the step of defining high and low raw input values.

30. A method for configuring a process control system according to claim 28 wherein the step of defining the prescribed information includes the step of defining default device state information if the process control peripheral is, at least in part, a digital device.

31. A method for configuring a process control system according to claim 28 wherein the step of defining the prescribed information includes the step of defining high and low engineering values and measurement increment information if the process control peripheral is, at least in part, an analogue device.

32. A method for configuring a process control system according to claim 28 wherein the step of defining the prescribed information includes the step of defining at least one of the following:
details of whether the process control peripheral is bipolar;
details of whether the process control peripheral is a DE device;
default output value.

33. A method for configuring a process control system according to claim 28 further including the steps of scanning all input/output ports of the programmable automation control for process control peripherals; and obtaining predetermined details regarding each process control peripheral detected.

34. A method for configuring a process control system according to claim 33 further including the steps of providing the predetermined details in respect of each detected process control peripheral to the user; and receiving confirmation from the user that the predetermined details correspond with the process control peripherals in data and control communication with the programmable automation controller.

35. A method for configuring a process control system according to claim 28, including the step of, for each process control peripheral, defining a channel through which the process control peripheral sends data and control communications to the programmable automation controller using the software program.

36. A method for configuring a process control system according to claim 33 including the step of automatically identifying each channel through which each process control peripheral send data and control communication to the programmable automation controller and providing that information as part of the determined details.

37. A method for configuring a process control system according to claim 28 including the steps of defining at least one environment and associating a shape with each defined environment.

38. A method for configuring a process control system according to claim 37 including the step of associating each process control peripheral with a defined environment.

39. A method for configuring a process control system according to claim 28 including the step of defining an image to be used to represent the process control peripheral.

40. A method for configuring a process control system according to claim 39, including the steps of defining at least one environment and associating a shape with each defined environment; associating each process control peripheral with a defined environment; and displaying, for each process control peripheral, the image used to represent each process control peripheral within the display of the shape associated with the environment to which the process control peripheral relates.

41. A method for configuring a process control system according to claim 28 including the step of indicating whether values recorded by the process control peripheral are to be logged in a database.

42. A method for configuring a process control system according to claim 41 including the step of defining the time interval to expire between logging of values in the database.

43. A method for configuring a process control system according to claim 28 including the additional steps of detailing the active state of the process control peripheral and, using the software, assisting the user to schedule when the process control peripheral is to change to the active state.

44. A method for configuring a process control system according to claim 28 including the additional steps of indicating whether the process control peripheral is the subject of an alarm; and indicating whether the process control peripheral is the subject of, or catalyst for, a trigger condition.

45. A method for configuring a process control system according to claim 44 including the steps of verifying that each process control peripheral indicated as being the subject of an alarm is the subject of a defined alarm condition; and verifying that each process control peripheral indicated as being the subject of, or catalyst for, a trigger condition is the subject of, or catalyst for, a defined trigger condition.

46. A method for configuring a process control system according to claim 28 including the step of defining a method of alarm from one of the following: Short Message Service message; e-mail; pager; speaker; phone.

47. A method for configuring a process control system according to claim 28 including the steps of detailing a time period to elapse before rechecking the trigger condition and a response to the trigger condition and initiating the response if the trigger condition still exists on rechecking.

48. A programmable automation controller for use in a process control system, the programmable automation controller in data and control communication with at least one process control peripheral, the programmable automation controller being operable to execute a single software program to assist a user to:
define prescribed information in respect of each process control peripheral, including configuration information;
define trigger conditions, if any, associated with the process control peripheral; and
define alarm conditions, if any, associated with the process control peripheral
the software program thereafter being operable to provide information in respect of the process control system to the user.

49. A programmable automation controller according to claim 48 wherein the software program is operable to scan all input/output ports of the programmable automation controller for process control peripherals and obtain predetermine details regarding each process control peripheral detected.

50. A programmable automation controller according to claim 49 wherein the software program is operable to provide the predetermined details in respect of each detected process control peripheral to the user and receive confirmation from the user that the predetermined details correspond with the process control peripherals in data and control communication with the programmable automation controller.

51. A programmable automation controller according to claim 48 wherein the software program is operable to assist the user to define a channel through which each process control peripheral sends data and control communication to the programmable automation controller.

52. A programmable automation controller according to claim 48 wherein the software program is operable to assist the user to define at least one environment and to associate a shape with each defined environment.

53. A programmable automation controller according to claim 52, wherein the software program is operable to display on a display means an image used to represent each process control peripheral within the display of the shape associated with the environment to which the process control peripheral relates.

54. A programmable automation controller according to claim 48 including a database for recording values recorded by prescribed process control peripherals.

55. A programmable automation controller according to claim 48 wherein the software program is operable to verify that each process control peripheral indicated as being the subject of an alarm is the subject of a defined alarm condition and that each process control peripheral indicated as being the subject of, or catalyst for, a trigger condition is the subject, or defined catalyst for, a defined trigger condition.

56. A programmable automation controller according to claim 48 wherein the software program includes means for simulating the operation of the process control system.

57. A programmable automation controller according to claim 48 wherein data and control communication with the at least one process control peripheral accords with a non-proprietary communication protocol.

58. A programmable automation controller according to claim 48 wherein data and control communication with the at least one process control peripheral is effected by at least one of the following means: cable, wireless, infrared or PCI/ISA card.

59. A programmable automation controller according to claim 48 wherein the software program is adapted to assist the user located remote to the programmable automation controller via a remote computer.

60. A computer for use in a process control system, the computer in data and control communication with at least one remote programmable automation controller, the at least one remote programmable automation controller in data and control communication with at least one process control peripheral, wherein, upon configuration of the process control system, the at least one remote programmable automation controller executes a single software program to assist a user of the computer to:
define prescribed information in respect of the at least one process control peripheral, including configuration information;
define trigger conditions, if any, associated with the at least one process control peripheral; and
define alarm conditions, if any, associated with the process control peripheral, the software program thereafter being operable to provide information in respect of the process control system to the user via the computer.

61. (canceled)

62. (canceled)

63. (canceled)

64. (canceled)
